(19) United States
(12) Patent Application Publication
(10) Pub. No.: US 2018/0126267 A1
(43) Pub. Date: May 10, 2018

(54) SOCIAL MEDIA APPLICATION AND SYSTEM FOR COURT GAMES

(71) Applicant: Danny Summerville, Hawthorne, CA (US)

(72) Inventor: Danny Summerville, Hawthorne, CA (US)

(21) Appl. No.: 15/345,988

(22) Filed: Nov. 8, 2016

(51) Int. Cl. A63F 13/35; H04W 4/02; G06F 3/0484; A63F 13/25; A63F 13/79; A63F 13/87; A63F 13/812; G06Q 50/00

(52) U.S. Cl. CPC A63F 13/35; H04W 4/025; G06F 3/0484; G06Q 50/01; A63F 13/79; A63F 13/87; A63F 13/812; A63F 13/25

(57) ABSTRACT

A computer processor of the mobile device may transmit a request to a server for other mobile devices present on one or more of the plurality of courts. The request may include a location of the mobile device. The computer processor may receive from the server on a display of the mobile device a graphical representation of a plurality of courts used in a court game that are within a predetermined radius of the location of the mobile device. The computer processor may receive from the server a listing of locations of one or more other mobile devices present on one or more of the plurality of courts. The listing may include one or more mobile devices having active user accounts associated with the court game. The computer processor may plot pins on the one or more of the plurality of courts on the display of the mobile device, the pins indicating the locations of the one or more mobile devices.

### TECHNICAL FIELD

The implementations of the disclosure relate generally to computing devices, and more specifically relate to a system and method for executing a social media application and system for court games.

### BRIEF DESCRIPTION OF THE DRAWINGS

Implementations of the disclosure will be more readily understood from the detailed description of exemplary embodiments considered in conjunction with the following drawings, of which:

FIG. 1 illustrates a conceptual diagram of a plurality of users each having mobile devices for communicating with each other during play of a court game located on a plurality of courts in a corresponding plurality of parks at various locations, according to implementations of the disclosure.

FIG. 2 illustrates a system employed by the plurality of users on their mobile devices for communicating with each other during play of the court game located on the plurality of courts in the corresponding plurality of parks at the various locations, according to implementations of the disclosure.

FIG. 3 illustrates an exemplary mobile device screenshot of an ihoop24 login screen, according to implementations of the disclosure.

FIG. 4 illustrates an exemplary mobile device screenshot of an ihoop24 user account home screen, according to implementations of the disclosure.

FIG. 5 illustrates an exemplary mobile device screenshot of an ihoop24 “Hoop Card” screen, according to implementations of the disclosure.

FIG. 6 illustrates an exemplary mobile device screenshot of an ihoop24 highlights screen, according to implementations of the disclosure.

FIG. 7 is an exemplary screen shot of a chat screen that the user may select when touching the chat button, according to implementations of the disclosure.

FIG. 8 is a process flow diagram illustrating a mobile device interacting with a user device and a server for communication during a court game, according to implementations of the disclosure.

FIG. 9 is a process flow diagram illustrating server device interacting with a mobile device of the user for communication with another mobile device of another user during a court game, according to implementations of the disclosure.

FIG. 10 illustrates a diagrammatic representation of a machine in the example form of a computer system within which a set of instructions, for causing the machine to perform any one or more of the methodologies discussed herein, may be executed, according to implementations of the disclosure.

### DETAILED DESCRIPTION

Implementations of the disclosure describe a social media application and system for court games. Court games may refer to any number of athletic games played on a court. In one implementation, a computer processor of a mobile device may transmit a request to a server, the request inquiring into whether other mobile devices are present on one or more of the plurality of courts. The request may include a location of the mobile device. In response to the request, the computer processor may receive from the server data to provide a graphical representation of a plurality of courts used in a court game. The graphical representation may be displayed on the mobile device to an end user via the social media application.

In one implementation, the plurality of courts may be within a predetermined radius of the location of the mobile device. The computer processor may receive from the server a listing of locations of one or more other mobile devices present on one or more of the plurality of courts. The listing may include one or more mobile devices having active user accounts associated with the court game. The computer processor may plot pins on the one or more of the plurality of courts on the graphical representation displayed on the mobile device, where the pins indicate the locations of the one or more mobile devices.

The computer processor may further transmit to the server a request to establish a connection to the one or more other mobile devices having active user accounts associated with the court game as indicated by the pins. The computer processor may receive from the server information to establish the requested connection to the one or more other mobile devices.

The computer processor may be further configured to employ a representational state transfer (REST) protocol and application programming interface (API) for the request, the receiving on the display, and the receiving the listing of locations. The computer processor may be further configured to receive a list of available parks having court locations within a predetermined radius of the location of the mobile device.

In the field of athletics, especially in tennis and basketball, a player may desire to start a game with other players whom they may not know. However, the other players may also seek to play a game. The other players may be on the same court in the same park or at another court at another location in the same park or another park. One player may not know when another player is ready to attend a court game. There may be a high school student who wants to go to a court to practice his or her skills and wants to find an open court to have no distractions, but may locate and then play a game with other players. Each player may be carrying a mobile device, such as a smart phone and/or a tablet. Previously solutions did not allow players to easily locate, discover, and communicate with other players (to whom a social connection may not be otherwise established) on another court. Previous solutions also did not enable the sharing aspects of social media for the specific purposes of the court game of the players. Implementations of the disclosure enable a community of players of a court game to communicate with one another during play of the court game, where the community of players may be dispersed over a plurality of courts in a corresponding plurality of parks at various locations.

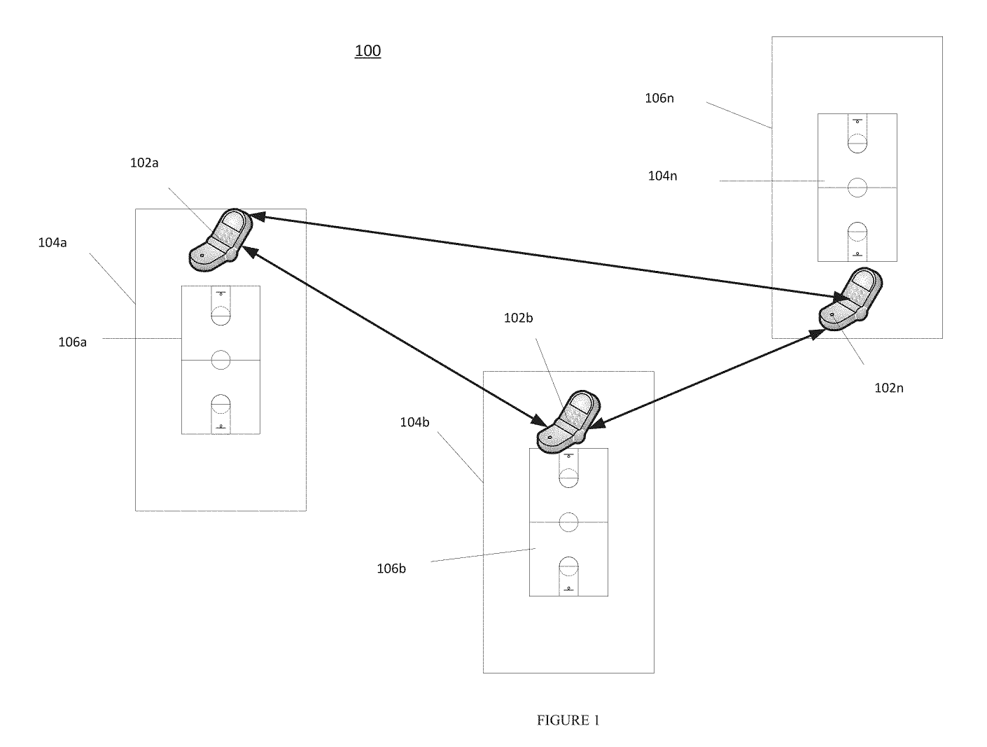

FIG. 1 illustrates a top-down view 100 of a plurality of users (not shown) each having mobile devices 102a-102n for communicating with each other during play of a court game located on a plurality of courts 104a-104n in a corresponding plurality of parks 106a-106n at various locations. Court games may refer to any number of athletic games played on a court, such as basketball, tennis, handball, volleyball, netball, lawn tennis, squash, racquetball, jai alai, badminton, deck tennis, pallone, fives, and so on.

The mobile devices 102a-102n may each include computing devices such as personal computers (PCs), laptops, mobile phones, smart phones, tablet computers, netbook computers, network-connected televisions, etc. In some implementations, mobile devices 102a-102n mat also be referred to as “user devices.” Each mobile device may include a media viewer. In one implementation, the media viewers may be applications that allow users to view content, such as images, videos, web pages, documents, etc. For example, the media viewer may be a web browser that can access, retrieve, present, and/or navigate content (e.g., web pages such as Hyper Text Markup Language (HTML) pages, digital media items, etc.) served by a web server. The media viewer may render, display, and/or present the content (e.g., a web page, a media viewer) to a user. The media viewer may also display an embedded media player (e.g., a Flash® player or an HTML5 player) that is embedded in a web page (e.g., a web page that may provide information about a product sold by an online merchant). In another example, the media viewer may be a standalone application (e.g., a mobile application or app) that allows users to view digital media items (e.g., digital videos, digital images, electronic books, etc.).

According to aspects of the disclosure, the media viewer may be a social media application specifically devoted to court games and for permitting players to locate and communicate with each other in the various parks. The players may be engaged in any type of sports game, including, but not limited to, and not strictly limited to, tennis, basketball, etc.

The venue of the court games may not be limited to parks, but may include indoor gymnasiums, outdoor courts in school yards, parks, or stadiums.

In some implementations, the mobile devices may connect to one another through a network (not shown). The network may include a public network (e.g., the Internet), a private network (e.g., a local area network (LAN) or wide area network (WAN)), a wired network (e.g., Ethernet network), a wireless network (e.g., an 802.11 network or a Wi-Fi network), a cellular network (e.g., a Long Term Evolution (LTE) network), routers, hubs, switches, server computers, and/or a combination thereof.

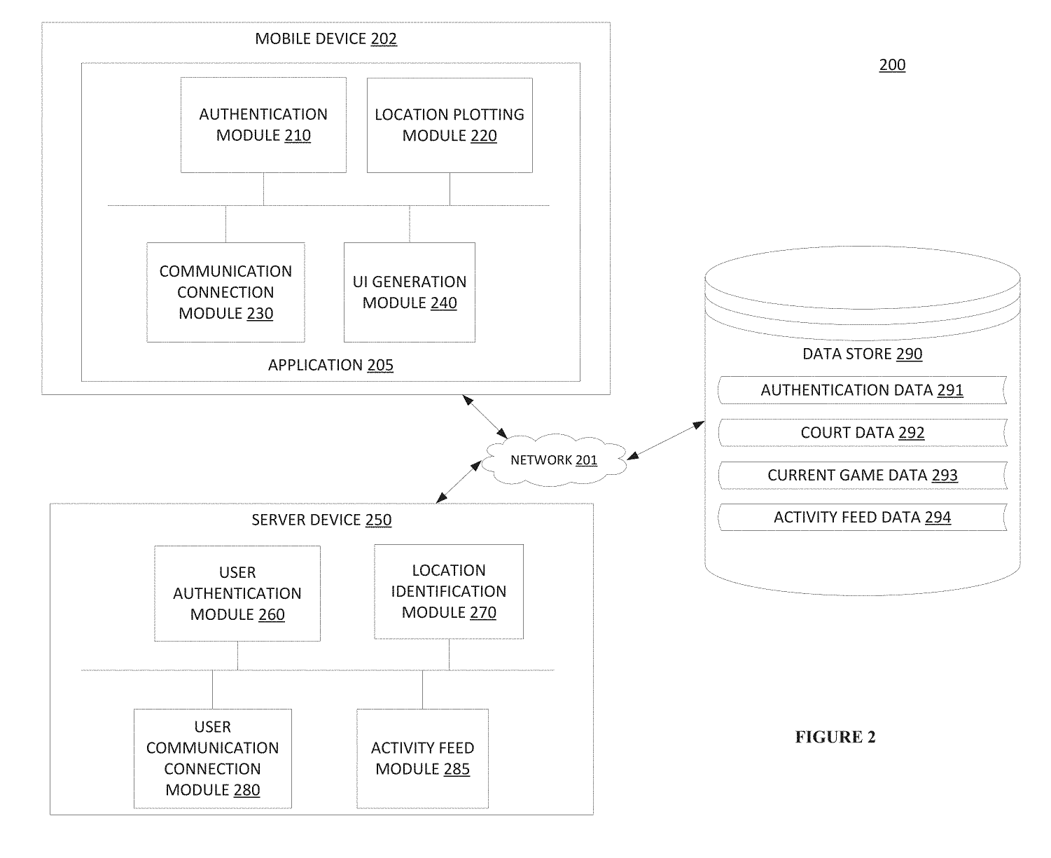

FIG. 2 is a system 200 for providing a social media application for court games. System 200 may include a mobile device 202 and a server device 250 communicably coupled via a network 201. In one implementation, mobile device 202 may be the same as mobile device 102a-120n described with respect to FIG. 1. Mobile device 202 may communicate with one or more other mobile devices (not shown) regarding play of a court game located on a plurality of courts, such as courts 104a-104n in a corresponding plurality of parks 106a-106n at various locations, such as described with respect to FIG. 1.

Mobile device 202 may execute a version of an application 205 for locating other players for a court game. Such an application 205 may be hereinafter referred to as the “ihoop24 application 205.” The ihoop24 application 205 executing on the mobile device 202 is configured to communicate (e.g., wirelessly) with a back end server device 250. For example, the mobile device 202 may be communicably coupled to the back end server 250 via a network 201. As discussed above, the network 201 may include a public network (e.g., the Internet), a private network (e.g., a local area network (LAN) or wide area network (WAN)), a wired network (e.g., Ethernet network), a wireless network (e.g., an 802.11 network or a Wi-Fi network), a cellular network (e.g., a Long Term Evolution (LTE) network), routers, hubs, switches, server computers, and/or a combination thereof.

The ihoop24 application 205 on mobile device 202 may be executed by a computer processor (not shown) of the mobile device 202. In one implementation, the ihoop24 application 205 includes an authentication module 210, a location plotting module 220, a communication connection module 230, and a user interface (UI) generation module 240. More or less components may be included in the ihoop24 application 205 without loss of generality. For example, two of the modules may be combined into a single module, or one of the modules may be divided into two or more modules. In one implementation, one or more of the modules may reside on different computing devices (e.g., different server computers, on a single client device, or distributed among multiple client devices, etc.).

The authentication module 210 of the ihoop24 application 205 may be configured to receive credentials from a user of the mobile device 202. In one implementation, the credentials may include a log in and a password provided by the user. Other forms of credentials may also be utilized in implementations of the disclosure. The authentication module 210 may determine that a user of the ihoop24 application 205 is authorized to use the ihoop24 application 205 and cause the user to be logged into the back end server device 250 corresponding to the ihoop24 application 205. The authentication module 210 may utilize authentication data 290 stored in a data store 290 communicably coupled to the mobile device 202 and/or the server device 250 via network 201. In some implementations, the data store 290 may be directly connected to either mobile device 202 and/or server device 250. In one implementation, the data store 290 may be a memory (e.g., random access memory), a cache, a drive (e.g., a hard drive), a flash drive, a database system, or another type of component or device capable of storing data. The data store 270 may also include multiple storage components (e.g., multiple drives or multiple databases) that may also span multiple computing devices (e.g., multiple server computers).

The location plotting module 220 may be configured to transmit a request to the server device 250 to identify other mobile devices (not shown) that are present (e.g., geographically-located) on one or more of the plurality of courts (e.g., 106b-106n). In one implementation, the request includes a location of the mobile device 202 sending the request. A global positioning system (GPS) device (not shown) of the mobile device 202 may be used to determine the geographic position of the mobile device 202.

In response to the request, the location plotting module 220 may receive a list of locations (“court listing”) (e.g., parks 104b-104n) having courts (e.g., 106b-106n) within a predetermined radius of the provided location of the mobile device 202. The location plotting module 220 may also receive, from the server 250, data representing a graphical representation of the plurality of courts (e.g., 106b-106n) in the court listing. The UI generation module 240 may utilize this received data to present (i.e., render in a display device of the mobile device 202) a graphical representation of a map having the court locations depicted in relation to the location of the mobile device 202.

The location plotting module 220 may also be configured to receive, from the server device 250, a listing of locations (“mobile device listing”) of one or more other mobile devices located at the one or more of the previously-identified plurality of courts (e.g., 104b-104n). The mobile device listing may include one or more mobile devices (e.g., 102a-102n) having active (e.g., logged in) user accounts for the ihoop24 application.

The location plotting module 220, in combination with the UI generation module 240 may plot indications (e.g., pins, icons, markers, etc.) on the graphical representation of the one or more plurality of courts that are displayed on the mobile device mobile device 202. Plotting may refer to marking indications on a chart or other display. For ease of description, the indications are referred to herein as “pins”, but implementations are not limited to such a representation. The pins may indicate the locations of the one or more mobile devices (e.g., 102a-102n).

In one implementation, the communication connection module 230 may be configured to receive a selection of one or more of the pins from the user of the mobile device 202. The communication connection module may transmit to the server device 250 a request for a connection to the one or more other mobile devices corresponding to the selected pins. The communication connection module 230 may receive from the server device 250, instructions to cause a communication connection to be established to the one or more other mobile devices (e.g., 102b-102n). The communication connection may enable a user of the mobile device 202 to communicate with one or more of the other active users on the one or more other mobile devices (102b-102n). The communication connection may be implemented via an interface provided by the ihoop24 application 205, or may be provided via other communication mediums such as email, text, and/or phone, to name a few examples. The ihoop24 application 205 may permit the user to stay in communication with the one or more other active accounts for a predetermined amount of time.

In one implementation, the UI generation module 240 of the ihoop24 application 205 may be configured to receive an activity feed from the server 250 related to the court game. An activity feed may refer to a list of recent activity pertaining to the ihoop24 application 205 that is pushed to the mobile device 202, where the recent activity is specific to the user of the ihoop24 application 205. In one example, the activity feed may include a post of the user of the mobile device 202 and the post of other users of the active accounts based on which of the other users are indicated on the mobile device 202 as connections (e.g., friends, etc.). The post of the user and/or the other users may include at least one of an image, a video, and/or a text.

In one implementation, the mobile device 202 utilizes a REST protocol and API for the communications with the server device 205 that are described above.

The mobile device 202, and in particular the ihoop24 application 205, may display settings related to the court game. In other implementations, the mobile device 202, and in particular the ihoop24 application 205, may further display highlights related to the court game.

Referring now to server device 250, server device 250 may be one or more computing devices (such as a rackmount server, a router computer, a server computer, a personal computer, a mainframe computer, a laptop computer, a tablet computer, a desktop computer, etc.), data stores (e.g., hard disks, memories, databases), networks, software components, and/or hardware components that may be used to interact with a running instance of an ihoop24 application 205 on a mobile device 202. For example, the server device 250 may provide support for user authentication, court locations, current court game data, user communication connections, and activity feed information for an ihoop24 application instance 205 executing on a mobile device 202. The server device 250 may also provide a website (e.g., a webpage) or application back-end software that may be used to provide a user with access to the ihoop24 application 205 functionality.

In one implementation, the server device 206 includes a user authentication module 260, a location identification module 270, a user communication connection module 280, and an activity feed module 285. More or less components may be included in the server device 250 without loss of generality. For example, two of the modules may be combined into a single module, or one of the modules may be divided into two or more modules. In one implementation, one or more of the modules may reside on different computing devices (e.g., different server computers, on a single client device, or distributed among multiple client devices, etc.).

As discussed above, the ihoop24 application 205 of a mobile device 202 interacts with server device 250 to cause a user to be authenticated and authorized for log in to the ihoop24 application 205. The user authentication module 260 may access authentication data 291 of data store 290 to confirm that a user can log into the ihoop24 application 205 and provide such confirmation to the mobile device 202. In addition, the user authentication module 260 may indicate that the user is currently logged in (e.g., in data store 290 or elsewhere).

In one implementation, the location identification module 270 server device 250 may receive, from an ihoop24 application 205, a request to identify other mobile devices (e.g., 102b-102n) present on one or more of the plurality of courts (e.g., 104b-104n). The received request may include a location of the mobile device 202. In response to the request, the location identification module 270 may reference the location of the mobile device 202 against court data 292 in data store 290 to determine available locations (e.g., parks 104b-104n) having courts (e.g., 106b-106n) within a predetermined radius of the location (e.g., 104a) of the mobile device 202. The location identification module 280 may transmit a list (“court listing”) of the determined available locations to the mobile device 202. In one implementation, the available locations in the court listing are based on a predetermined distance from the location of the mobile device 202.

The location identification module 270 may also determine a listing (“mobile device listing”) of locations of one or more other mobile devices (102b-102n) present (e.g., geographically located) on one or more of the plurality of courts (104b-104n). The mobile device listing may include identification and location of one or more mobile devices (102b-102n) having active user accounts associated with a court game at any of the locations provided in the court listing. The location identification module 270 may access current game data 293 in data store 290 to identify the one or more other mobile devices of the mobile device listing. The location identification module 270 may transmit the mobile device listing to the mobile device 202. The location identification module 280 may transmit a listing (“pin listing”) of indicators (e.g., pins) and corresponding locations of the pins on the one or more of the plurality of courts in the court listing, where the pins in the pin listing may be displayed in a graphical user interface (UI) on the mobile device 202. The pins may indicate the locations of the one or more mobile devices (102a-102n) in the mobile device listing.

The user communication connection module 280 may receive from the mobile device 202 a selection of one or more of the pins from the provided pin listing. In addition, the user communication connection module 280 may receive from the mobile device 202 a request for a communication connection to one or more other mobile devices (e.g., 102b-102n) having active user accounts associated with the court game as indicated by the selection of the pins. The user communication connection module 280 may cause the communication connection to be established between the mobile device 202 and the one or more other mobile devices (e.g., 102b-102n) by sending instructions to the mobile device regarding how to establish contact with the one or more other mobile devices. The communication connection may be implemented via an interface provided by the ihoop24 application 205, or may be provided via other communication mediums such as email, text, and/or phone, to name a few examples. The ihoop24 application 205 may permit the user to stay in communication with the one or more other active accounts for a predetermined amount of time.

In one implementation, the activity feed module 285 may generate and transmit to mobile device 202 an activity feed corresponding to a user logged into an instance of an ihoop24 application 205 executing on the mobile device 202. The activity feed may refer to a list of recent activity pertaining to the ihoop24 application 205 that is pushed to the mobile device 202, where the recent activity is specific to the user of the ihoop24 application 205. In one example, the activity feed may include a post of the user of the mobile device 202 and the post of other users of the active accounts based on which of the other users are indicated on the mobile device 202 as connections (e.g., friends, etc.). The post of the user and/or the other users may include at least one of an image, a video, and/or a text. The activity feed module 285 may reference activity feed data 294 of data store 290 in order to generated the activity feed for the user. Activity feed data 294 may include, but is not limited to, rules to apply to activity of the ihoop24 application in order to generate a user's activity feed.

As previously discussed above, in some implementations, the server device 250 may implement a REST protocol and API for receiving the above-described communications with the mobile device 202.

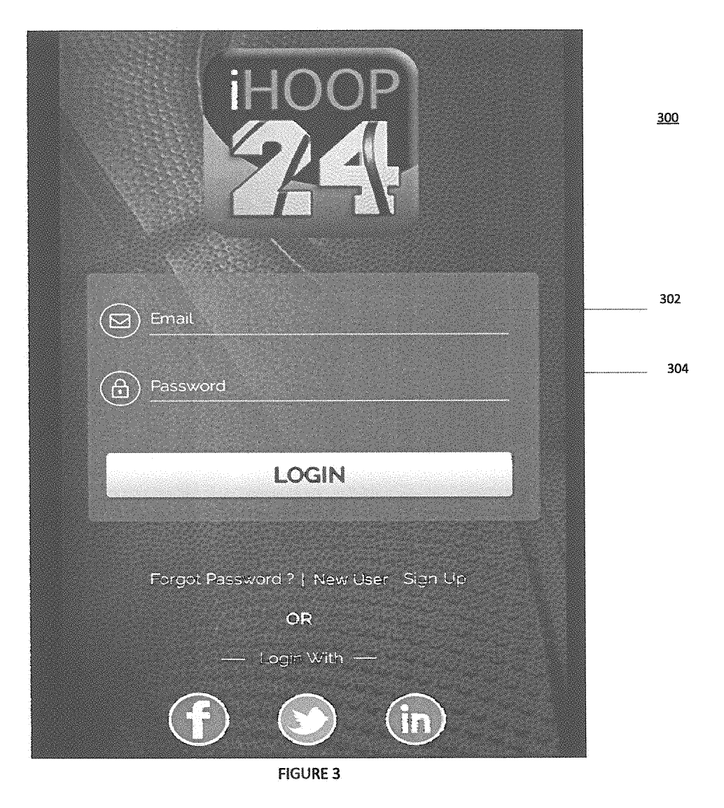

FIG. 3 illustrates a mobile device screenshot 300 of the ihoop24 login screen. After a user creates a login account, with, for example, an email address as the login entry 302 and a password entry 304, the user enters an iHoop24 account through a communication between the mobile device (e.g., 102a) and the server 250.

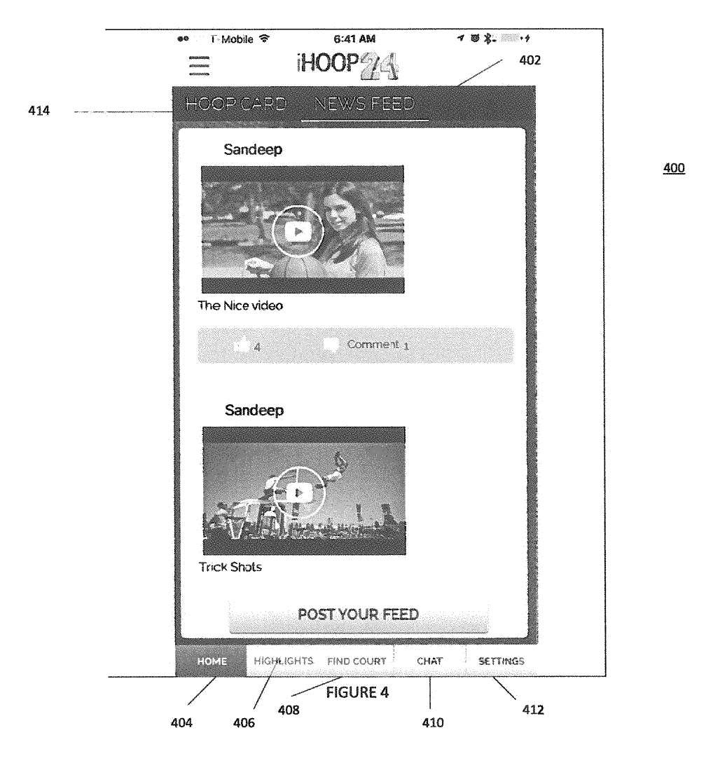

FIG. 4 illustrates a mobile device screenshot of the ihoop24 of a user account home screen or menu 400. The server 250 may provide the mobile device (e.g. 106a) with a personal activity feed 402. At the bottom of the screen 400 is a set of push button items including a home screen button 404, a highlights button 406, a find court button 408, a chat button 410, and a settings button 412. The user is initially presented with the home screen and the activity feed. The activity feed may contain posts that the user and/or posts of other users of the iHoop24 app that are “friended.” The posts may further include pictures, videos, or written text.

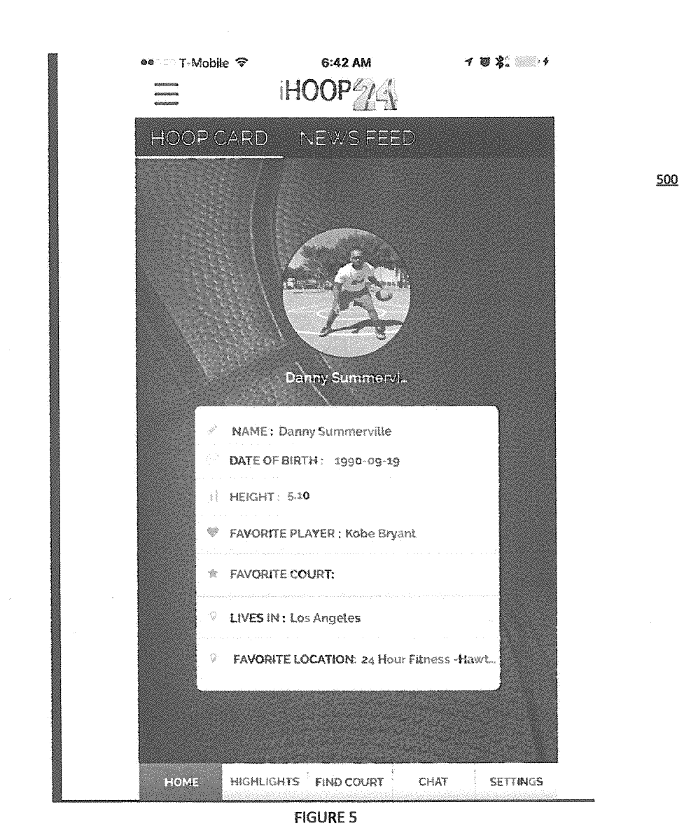

The user may select a “Hoop Card” screen as shown in FIG. 5. The “Hoop Card” screen may display things basketball related, such as height, weight, location, favorite court, name, date of birth, favorite location to play basketball and favorite basketball player (similar to a sports card).

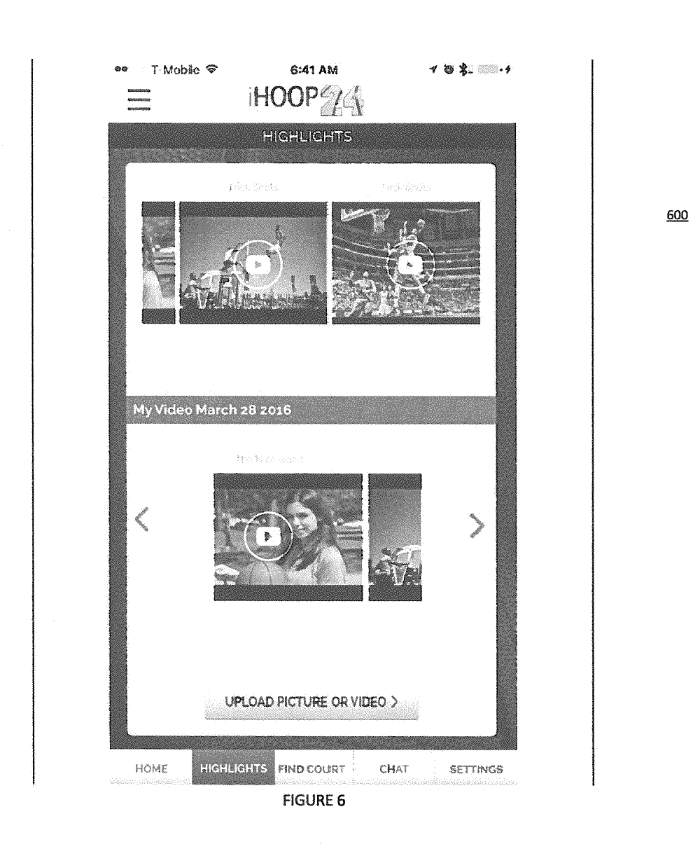

When the user selects the highlights button 406, the user is transferred to a highlights menu screen 600 as shown in FIG. 6. Users' highlights are shown. Highlights are a basketball reference referring to excited or celebrated moments in the game of basketball. Items (pictures or videos) that the user shares may be stored in his/her “highlights” section of a database associated with the server 250.

When the user selects the find court button 408, the user may locate a park or a gym. The user may further view the number of users that have the ihoop24 app installed in their mobile device, that and are actively using the app, and that are on a court in one of a plurality of parks or gyms. There may be a time span limit, e.g., 2 hours, wherein the stays active on the court. After the time span limit expires, the user may be automatically logged out of the ihoop24 application. If the user desires to stay at the court longer, the user may have the option of re-activating their time amount. This may be accomplished using a check in feature (not shown), which may be a button they press in the ihoop24 app.

More particularly, in find court screen, on the basis of location, pins may be plotted on a map located on a screen of a mobile device (e.g., 102a). A mobile device location address may be transmitted to the server 250. The server 250 may obtain a list of available parks based on a pre-determined radius from the location address of the mobile device (e.g., 102a). By selecting a check in option on the find court screen, the mobile device (e.g., 104a-104n) of each active user may transmit an indication to the server 250 of checked in users on various courts/parks. Communication between the mobile devices (e.g., 104a-104n) and the server 250 may be made possible by employing the representational state transfer protocol and application programming interface (API) between a client program on the mobile devices (e.g., 106a-106n) and a server program on the server 250.

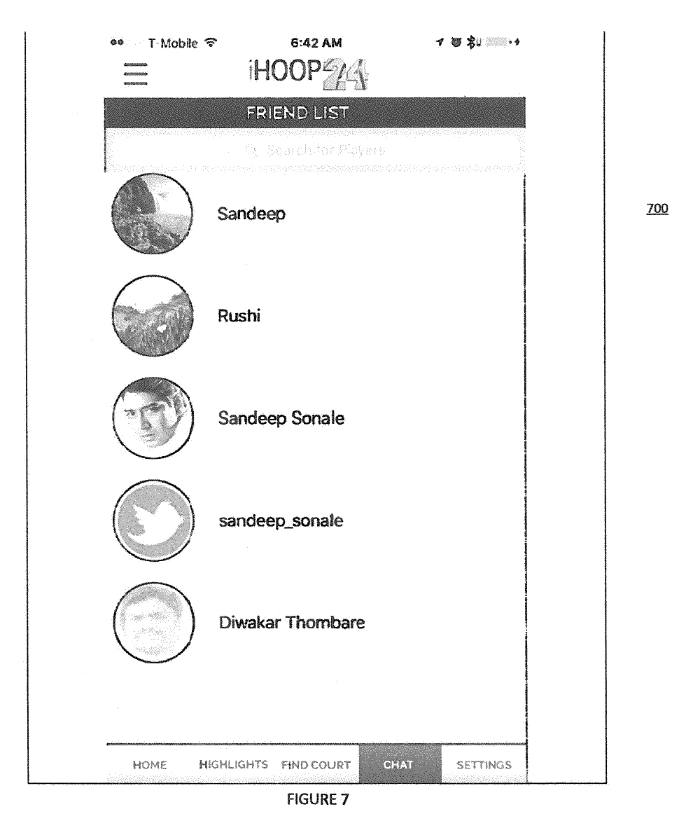

FIG. 7 is a screen shot of a chat screen 700 that the user may select when touching the chat button 410. Under the chat screen 700, the user may be provided with a location to chat with other players. When the user selects the settings button 412, the user may provide their profile information (not shown).

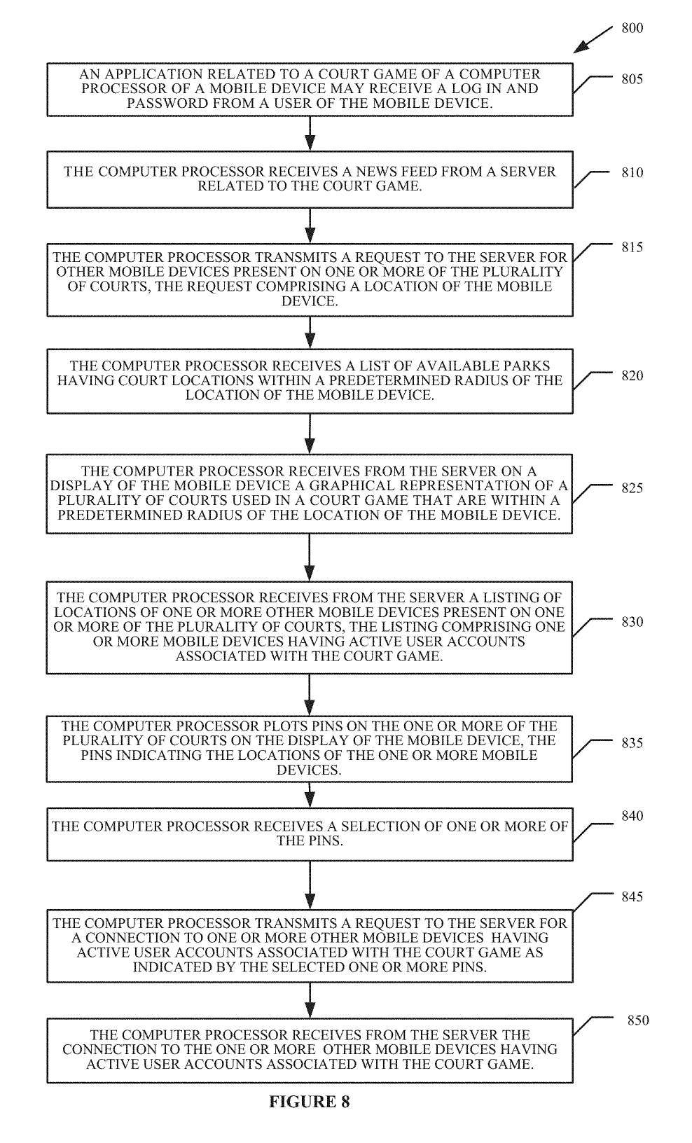

FIG. 8 is a process flow diagram 800 illustrating the mobile device interacting with the user and the server for communication during a court game. The method 800 may be performed by a computer system 200 of FIG. 2 which encompasses the computer processor (not shown) of the mobile device (e.g., 102a) of FIG. 2 and may comprise hardware (e.g., circuitry, dedicated logic, programmable logic, microcode, etc.), software (e.g., instructions run on a processing device), or a combination thereof. In one example, the method 800 may be performed by the ihopp24 app residing on a computer processor (not shown) of a mobile device (e.g., 102a) of FIG. 2.

As illustrate in FIG. 8, at block 805, the ihoop24 application related to the court game of a computer processor of the mobile device (e.g., 102a) of a user may receive a log in and password from the user. In one example, the court game may be basketball.

At block 810, the computer processor may receive an activity feed from a server 250 related to the court game. At block 815, the computer processor may transmit a request to the server 250 for other mobile devices (e.g., 102b-102n) present on one or more of the plurality of courts (e.g., 106a-106n), the request comprising a location of the mobile device (e.g., 102a).

At block 820, the computer processor may receive a list of available parks (e.g., 104a-104n) having court locations within a predetermined radius of the location of the mobile device (e.g., 102a). At block 825, the computer processor may receive from the server 250 on a display of the mobile device (e.g., 102a) a graphical representation of a plurality of courts (e.g., 106a-106n) used in a court game that are within a predetermined radius of the location of the mobile device (e.g., 102a). At block 830, the computer processor may receive from the server 250 a listing of locations of one or more other mobile devices (e.g., 102b-102n) present on one or more of the plurality of courts (e.g., 106b-106n), the listing comprising one or more mobile devices (e.g., 102b-102n) having active user accounts associated with the court game.

At block 835, the computer processor may plot pins on the one or more of the plurality of courts (e.g., 106a-106n) on the display of the mobile device (e.g., 106a). The pins may indicate the locations of the one or more mobile devices (e.g., 102b-102n). At block 840, the computer processor may receive a selection of one or more of the pins from the user.

At block 845, the computer processor may transmit to the server 200, a request for a connection to one or more other mobile devices (e.g., 102b-102n) having active user accounts associated with the court game by a selection by the user of one or more of the pins. At block 850, the computer processor may receive from the server 250, the connection to the one or more other mobile devices (e.g., 102b-102n) having active user accounts associated with the court game.

The computer processor may employ the representational state transfer protocol and application programming interface (API) for the request, the receiving on the display, and the receiving the listing of locations.

The computer processor may receive from the server 250, an activity feed related to the court game. The activity feed may include a post of the user of the mobile device (e.g., 102a) and the post of other users of the active accounts based on which of the other users are indicated on the mobile device (e.g., 102a) as friends. The post of the user and/or the other users may include at least one of a picture, a video, or text.

The computer processor may display on the display settings related to the court game.

The computer processor may further display on the display highlights related to the court game.

The mobile device (e.g., 102a) may permit a user to chat with one or more of the other active users. The mobile device (e.g., 102a) may permit the user to stay in communication with the one or more other active accounts for a predetermined amount of time.

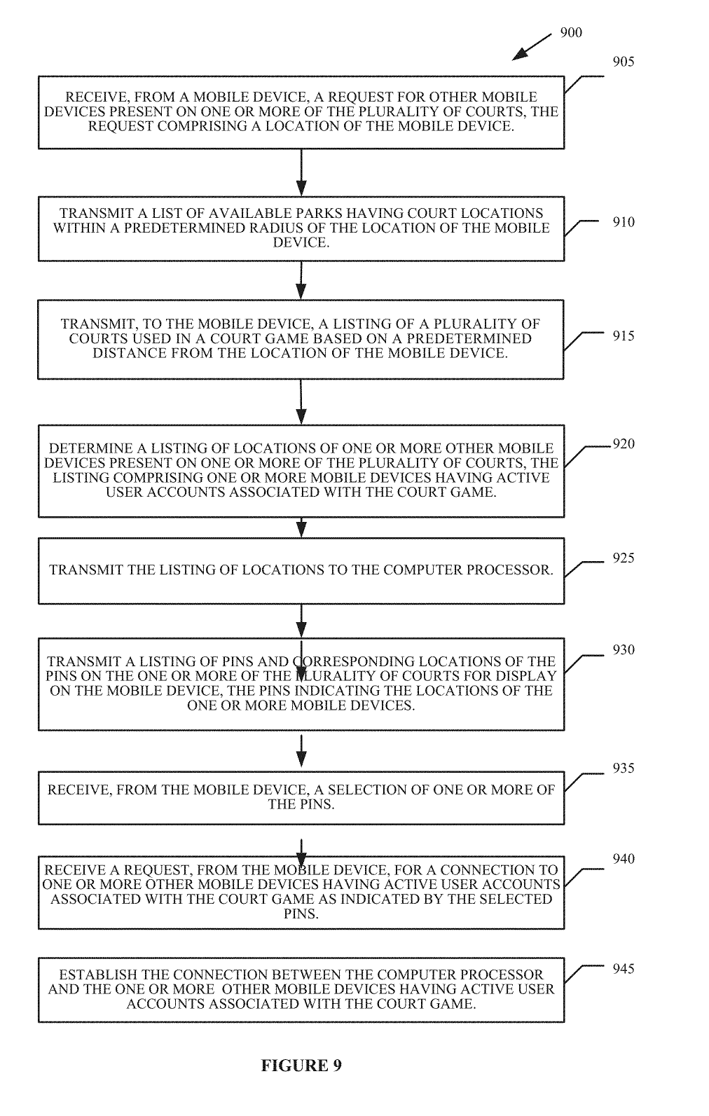

FIG. 9 is a process flow diagram 900 illustrating server 250 interacting with a mobile device (e.g., 102a) of the user for communication with another mobile device (e.g., 102b) of another user during a court game. In one example, the court game may be basketball. The method 900 may be performed by a computer system 200 of FIG. 2 which encompasses the server 250 of FIG. 2 and may comprise hardware (e.g., circuitry, dedicated logic, programmable logic, microcode, etc.), software (e.g., instructions run on a processing device), or a combination thereof. In one example, the method 900 may be performed by the server 250 of FIG. 2.

As illustrate in FIG. 9, at block 905, a server 250 may receive from a computer processor of a mobile device (e.g., 102a) a request for other mobile devices (e.g., 102b-102n) present on one or more of the plurality of courts (e.g., 106b-106n), the request comprising a location of the mobile device (e.g., 102a). At block 910, the server 250 may transmit a list of available parks (e.g., 104b-104n) having court locations within a predetermined radius of the location of the mobile device (e.g., 102a). At block 915, the server 250 may transmit to the computer processor a listing of a plurality of courts (e.g., 106b-106n) used in a court game based on a predetermined distance from the location of the mobile device (e.g., 102a).

At block 920, the server 250 may determine a listing of locations of one or more other mobile devices (e.g., 102b-102n) present on one or more of the plurality of courts (e.g., 106b-106n), the listing comprising one or more mobile devices (e.g., 102b-102n) having active user accounts associated with the court game. At block 925, the server 250 may transmit the listing of locations to the computer processor. At block 930, the server 250 may transmit a listing of pins and corresponding locations of the pins on the one or more of the plurality of courts (e.g., 106a-106n) for display on the mobile device (e.g., 102a), the pins indicating the locations of the one or more mobile devices (e.g., 102b-102n). At block 935, the server 250 may receive from the computer processor a selection of one or more of the pins.

At block 940, the server 250 may receive from the mobile device (e.g., 102a) a request for a connection to one or more other mobile devices (e.g., 102b-102n) having active user accounts associated with the court game as indicated by the selected pins. At block 945, the server 250 may establish the connection between the mobile device (e.g., 102a) and the one or more other mobile devices (e.g., 102b-102n) having active user accounts associated with the court game.

The server 250 may employ the representational state transfer protocol and application programming interface (API) for the request, the transmitting the listing of a plurality of courts (e.g., 106a-106n), the transmitting the listing of locations of one or more other mobile devices (e.g., 102b-102n), and the transmitting the listing of pins.

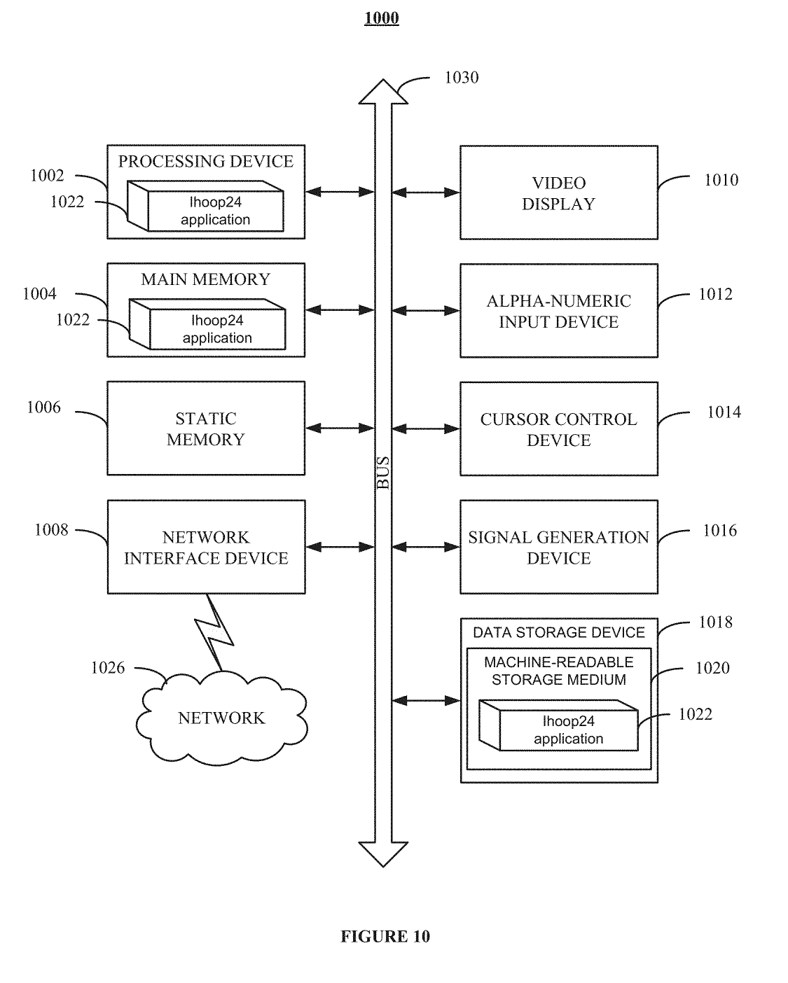

FIG. 10 illustrates a diagrammatic representation of a machine in the exemplary form of a computer system 1000 within which a set of instructions, for causing the machine to perform any one or more of the methodologies discussed herein, may be executed. In alternative embodiments, the machine may be connected (e.g., networked) to other machines in a local area network (LAN), an intranet, an extranet, or the Internet. The machine may operate in the capacity of a server or a client machine in a client-server network environment, or as a peer machine in a peer-to-peer (or distributed) network environment. The machine may be a personal computer (PC), a tablet PC, a set-top box (STB), a personal digital assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 1000 includes a processing device 1002, a main memory 1004 (e.g., read-only memory (ROM), flash memory, dynamic random access memory (DRAM) (such as synchronous DRAM (SDRAM) or Rambus DRAM (RDRAM), etc.), a static memory 1006 (e.g., flash memory, static random access memory (SRAM), etc.), and a data storage device 1018, which communicate with each other via a bus 1030.

Processing device 1002 represents one or more general-purpose processing devices such as a microprocessor, central processing unit, or the like. More particularly, the processing device may be complex instruction set computing (CISC) microprocessor, reduced instruction set computer (RISC) microprocessor, very long instruction word (VLIW) microprocessor, or processor implementing other instruction sets, or processors implementing a combination of instruction sets. Processing device 1002 may also be one or more special-purpose processing devices such as an application specific integrated circuit (ASIC), a field programmable gate array (FPGA), a digital signal processor (DSP), network processor, or the like. Processing device 1002 is configured to execute the ihoop24 application 1022 for performing the operations and steps discussed herein.

Computer system 1000 may further include a network interface device 1008. Computer system 1000 also may include a video display unit 1010 (e.g., a liquid crystal display (LCD) or a cathode ray tube (CRT)), an alphanumeric input device 1012 (e.g., a keyboard), a cursor control device 1014 (e.g., a mouse), and a signal generation device 1016 (e.g., a speaker).

Data storage device 1018 may include a machine-readable storage medium (or more specifically a computer-readable storage medium) 1020 having one or more sets of instructions embodying any one or more of the methodologies of functions described herein. The ihoop24 application 1022 may also reside, completely or at least partially, within main memory 1004 and/or within processing device 1002 during execution thereof by computer system 1000; main memory 1004 and processing device 1002 also constituting machine-readable storage media. The ihoop24 application 1022 may further be transmitted or received over a network 1026 via network interface device 1008.

Machine-readable storage medium 1020 may also be used to store the ihoop24 application 1022 persistently. While machine-readable storage medium 1020 is shown in an exemplary embodiment to be a single medium, the term “machine-readable storage medium” should be taken to include a single medium or multiple media (e.g., a centralized or distributed database, and/or associated caches and servers) that store the one or more sets of instructions. The term “machine-readable storage medium” shall also be taken to include any medium that is capable of storing or encoding a set of instruction for execution by the machine and that causes the machine to perform any one or more of the methodologies of the disclosure. The term “machine-readable storage medium” shall accordingly be taken to include, but not be limited to, solid-state memories, and optical and magnetic media.

The components and other features described herein can be implemented as discrete hardware components or integrated in the functionality of hardware components such as ASICs, FPGAs, DSPs or similar devices. In addition, these components can be implemented as firmware or functional circuitry within hardware devices. Further, these components can be implemented in any combination of hardware devices and software components.

Some portions of the detailed descriptions are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, as apparent from the above discussion, it is appreciated that throughout the description, discussions utilizing terms such as “enabling”, “transmitting”, “requesting”, “identifying”, “querying”, “retrieving”, “forwarding”, “determining”, “passing”, “processing”, “disabling”, or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments of the disclosure also relate to an apparatus for performing the operations herein. This apparatus may be specially constructed for the required purposes or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs and magnetic-optical disks, read-only memories (ROMs), random access memories (RAMs), EPROMs, EEPROMs, magnetic or optical cards, flash memory devices including universal serial bus (USB) storage devices (e.g., USB key devices) or any type of media suitable for storing electronic instructions, each of which may be coupled to a computer system bus.

The algorithms and displays presented herein are not inherently related to any particular computer or other apparatus. Various general purpose systems may be used with programs in accordance with the teachings herein or it may prove convenient to construct more specialized apparatus to perform the required method steps. The required structure for a variety of these systems will be apparent from the description above. In addition, the disclosure is not described with reference to any particular programming language. It will be appreciated that a variety of programming languages may be used to implement the teachings of the disclosure as described herein.

It is to be understood that the exemplary embodiments are merely illustrative of the disclosure and that many variations of the above-described embodiments may be devised by one skilled in the art without departing from the scope of the disclosure. The scope of the disclosure should, therefore, be determined with reference to the appended claims, along with the full scope of equivalents to which such claims are entitled.

What is claimed is:

1. A method, comprising:
transmitting, by a computer processor of a mobile device, a request to a server for other mobile devices present on one or more of the plurality of courts, the request comprising a location of the mobile device;
receiving, by the computer processor from the server, on a display of the mobile device a graphical representation of a plurality of courts used in a court game that are within a predetermined radius of the location of the mobile device;
receiving, by the computer processor from the server, a listing of locations of one or more other mobile devices present on one or more of the plurality of courts, the listing comprising one or more mobile devices having active user accounts associated with the court game as indicated by the pins; and
plotting, by the computer processor, pins on the one or more of the plurality of courts on the display of the mobile device, the pins indicating the locations of the one or more mobile devices.

2. The method of claim 1, further comprising:
transmitting, by the computer processor to the server, a request to the server for a connection to one or more other mobile devices having active user accounts associated with the court game as indicated by the pins; and
receiving, by the computer processor from the server, the connection to the one or more other mobile devices having active user accounts associated with the court game.

3. The method of claim 1, further comprising employing, by the computer processor, the representational state transfer protocol and application programming interface (API) for the request, the receiving on the display, and the receiving the listing of locations.

4. The method of claim 1, further comprising receiving a list of available parks having court locations within a predetermined radius of the location of the mobile device.

5. The method of claim 1, further comprising receiving, by the computer processor from the server, an activity feed related to the court game.

6. The method of claim 5, further comprising, receiving, from the activity feed, a post of the user of the mobile device and the post of other users of the active accounts based on which of the other users are indicated on the mobile device as friends.

7. The method of claim 6, wherein the post of the user and/or the other users comprises at least one of a picture, a video, or text.

8. The method of claim 1, further comprising displaying, by the computer processor on the display, settings related to the court game.

9. The method of claim 1, further comprising, displaying, by the computer processor on the display, highlights related to the court game.

10. The method of claim 1, further comprising, permitting, by the mobile device, a user to chat with one or more of the other active users.

11. The method of claim 1, further comprising, permitting the user to stay in communication with the one or more other active accounts for a predetermined amount of time.

12. The method of claim 1, wherein the court game is basketball.

13. A system, comprising:
a memory;
a computer processor of a mobile device operatively coupled to the memory, to:
transmit a request to a server for other mobile devices present on one or more of the plurality of courts, the request comprising a location of the mobile device;
receive, from the server, on a display of the mobile device a graphical representation of a plurality of courts used in a court game that are within a predetermined radius of the location of the mobile device;
receive, from the server, a listing of locations of one or more other mobile devices present on one or more of the plurality of courts, the listing comprising one or more mobile devices having active user accounts associated with the court game; and
plot pins on the one or more of the plurality of courts on the display of the mobile device, the pins indicating the locations of the one or more mobile devices.

14. The system of claim 13, wherein the computer processor is further to:
transmit a request to the server for a connection to one or more other mobile devices having active user accounts associated with the court game as indicated by the pins; and
receive, from the server, the connection to the one or more other mobile devices having active user accounts associated with the court game.

15. The system of claim 13, wherein the computer processor is further to employ the representational state transfer protocol and application programming interface (API) for the for the request, the receiving on the display, and the receiving the listing of locations.

16. The system of claim 13, wherein the computer processor is further to receive a list of available parks having court locations within a predetermined radius of the location of the mobile device.

17. A non-transitory machine-readable storage medium storing instructions which, when executed, cause a processing device to perform operations comprising:
receiving, by the processing device of a server device, a request from a mobile device, the request to locate other mobile devices present on one or more of the plurality of courts and comprising a location of the mobile device;
transmitting, by the processing device of the server device to the mobile device a listing of a plurality of courts used in a court game based on a predetermined distance from the location of the mobile device;
determining, by the processing device, a listing of locations of one or more other mobile devices present on one or more of the plurality of courts, the listing comprising one or more mobile devices having active user accounts associated with the court game;
transmitting, by the processing device, the listing of locations to the mobile device; and
transmitting, by the processing device, a listing of pins and corresponding locations of the pins on the one or more of the plurality of courts for display on the mobile device, the pins indicating the locations of the one or more mobile devices.

18. The non-transitory machine-readable storage medium of claim 17, wherein the operations further comprise:
receiving a request for a connection to one or more other mobile devices having active user accounts associated with the court game as indicated by the pins; and
establishing the connection between the computer processor and the one or more other mobile devices having active user accounts associated with the court game.

19. The non-transitory machine-readable storage medium of claim 17, wherein the operations further comprise utilizing the representational state transfer protocol and application programming interface (API) for the request, the transmitting the listing of a plurality of courts, the transmitting the listing of locations of one or more other mobile devices, and the transmitting the listing of pins.

20. The non-transitory machine-readable storage medium of claim 17, wherein the operations further comprise transmitting, to the mobile device, a list of available parks having court locations within a predetermined radius of the location of the mobile device.
